(19) United States
(12) Patent Application Publication
(10) Pub. No.: US 2023/0032715 A1
(43) Pub. Date: Feb. 2, 2023

(54) ONE-WAY OPTICAL LINK FOR PRECISION FREQUENCY TRANSFER BETWEEN STATIONARY OR MOVING PLATFORMS

(71) Applicant: OEWAVES, INC., Pasadena, CA (US)

(72) Inventor: Lute MALEKI, Pasadena, CA (US)

(21) Appl. No.: 17/872,344

(22) Filed: Jul. 25, 2022

Related U.S. Application Data
(60) Provisional application No. 63/226,067, filed on Jul. 27, 2021.

(51) Int. Cl. H04B 10/61

(52) U.S. Cl. CPC H04B 10/61

(57) ABSTRACT

A photonic system is described that employs, in some examples, a pair of ultra-low noise semiconductor lasers that produce a low noise electrical signal at the output of a photodetector at a remote location with a frequency set by a frequency interval between the two lasers. The two lasers are phase locked together and mutually locked to a high stability source (such as an atomic clock) at any convenient frequency (e.g., 100 MHz, X-band, Ka-band, W-band, etc.). Upon impinging on the photodetector at the receive location, a combined or merged version of the two laser beams produces a stabilized beat note at the output of the photodetector. Since during transmission both lasers, propagating at the phase velocity, suffer the same frequency deviation due to atmospheric perturbation or motion of the receiver platform, any frequency variations will substantially cancel at the output beat note produced by the photodetector.

### PRIORITY CLAIM AND CROSS-REFERENCE TO RELATED APPLICATION

This patent document claims the priority of U.S. Provisional Application No. 63/226,067, entitled “ONE-WAY, FREE SPACE OPTICAL LINK FOR PRECISION FREQUENCY TRANSFER BETWEEN STATIONARY OR MOVING PLATFORMS,” filed on Jul. 27, 2021, the entire disclosure of which is incorporated by reference herein.

### FIELD OF THE DISCLOSURE

Various aspects of the disclosure relate to photonic systems.

### BACKGROUND

Stability transfer from a local high stability source such as an atomic clock is important for a variety of applications ranging from arrayed antennas and satellite systems to navigation and phase coherent detection with remote platforms. Advanced communications systems may require stable frequency and time information delivered from a remote high stability source. Depending on the application, the source is located at a distance of several centimeters (cm) to few meters (m) to many kilometers (km) away from a stationary or moving platform (e.g., at least one km away in terrestrial applications and 100 s to many 1000 s of km in space applications). This capability is difficult to realize without degradation of the stability of the source due to perturbation of the signal caused by environmental (temperature, pressure, etc.) effects on the medium in which the signal propagates. In satellite systems, for example, the frequency of a transmitted carrier on which the source signal is modulated changes due to atmospheric perturbation, degrading the signal received at the distant location. Similarly, in fiber based systems, change of temperature of the fiber results in change of the index of refraction, impacting the quality of the reference signal being transmitted through dispersion, and by degradation of the signal to noise ratio.

Because of these challenges, optical frequency transfer using a laser carrying modulated signal produced by a high stability source has been proposed and utilized. Recently this approach has been implemented with a single sideband modulator, or two lasers at different wavelength both modulated with the same reference, or have been proposed and demonstrated to achieve higher quality one-way time and stability transfer. More sophisticated systems utilizing an optical frequency comb have also been demonstrated. These approaches are relatively complex and often require high power optical transmitters to ensure sufficient signal to noise at the receiver end; otherwise, the performance of the system is degraded. Nevertheless, it is important to note that all these schemes involved a two-way, active stabilization of the frequency transfer links. The complexity may make these systems prohibitive for many terrestrial and space applications, especially where size, weight, power and cost are restricted.

A new approach is needed for a simplified and high-performance one-way frequency and time transfer.

### SUMMARY

In one aspect, an optical system is provided that includes: first and second coherent optical sources configured to generate first and second coherent optical beams, respectively; a locking circuit configured to phase lock the first and second coherent optical sources to a stable signal source; a transmitter configured to transmit a combined optical beam to a remote location, the combined optical beam comprising a combination of the first and second coherent optical beams, the combined optical beam having a beat frequency representative of a difference in frequency between the first and second coherent optical beams; a receiver at the remote location configured to receive the combined optical beam; and a photodetector at the remote location configured to generate an output electrical signal from the combined optical beam based on the beat frequency that is representative of the difference in frequency between the first and second coherent optical beams.

In another aspect, a method is provided that includes: generating first and second coherent optical beams using first and second coherent optical sources, respectively, while phase locking the first and second coherent optical sources to a stable signal from a stable signal source; transmitting a combined optical beam to a remote location, the combined optical beam comprising a combination of the first and second coherent optical beams, the combined optical beam having a beat frequency representative of a difference in frequency between the first and second coherent optical beams; receiving the combined optical beam at the remote location using a receiver; and applying the received combined optical beam to a photodetector to generate an output electrical signal based on the beat frequency that is representative of the difference in frequency between the first and second coherent optical beams.

In yet another aspect, an apparatus is provided that includes: means for generating first and second coherent optical beams using first and second coherent optical sources, respectively, while phase locking the first and second coherent optical sources to a stable signal from a stable signal source; means for transmitting a combined optical beam to a remote location, the combined optical beam comprising a combination of the first and second coherent optical beams, the combined optical beam having a beat frequency representative of a difference in frequency between the first and second coherent optical beams; means for receiving the combined optical beam at the remote location using a receiver; and means for applying the received combined optical beam to a photodetector to generate an output electrical signal based on the beat frequency that is representative of the difference in frequency between the first and second coherent optical beams.

### BRIEF DESCRIPTION OF THE DRAWINGS

FIG. 1 illustrates an exemplary photonic system configured for one-way, free space optical transmissions between stationary or moving platforms.

FIG. 2 illustrates another an exemplary photonic system configured for one-way, free space optical transmissions between stationary or moving platforms.

FIG. 3 illustrates an exemplary photonic system with multiple receivers.

FIG. 4 is a flow diagram illustrating an exemplary in accordance with aspects of the disclosure.

FIG. 5 illustrates an exemplary optical system in accordance with aspects of the disclosure.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure. In the figures, elements may each have a same reference number or a different reference number to suggest that the elements represented could be different and/or similar. However, an element may be flexible enough to have different implementations and work with some or all of the systems shown or described herein. The various elements shown in the figures may be the same or different and, which one is referred to as a first element and which is called a second element is arbitrary.

### Overview

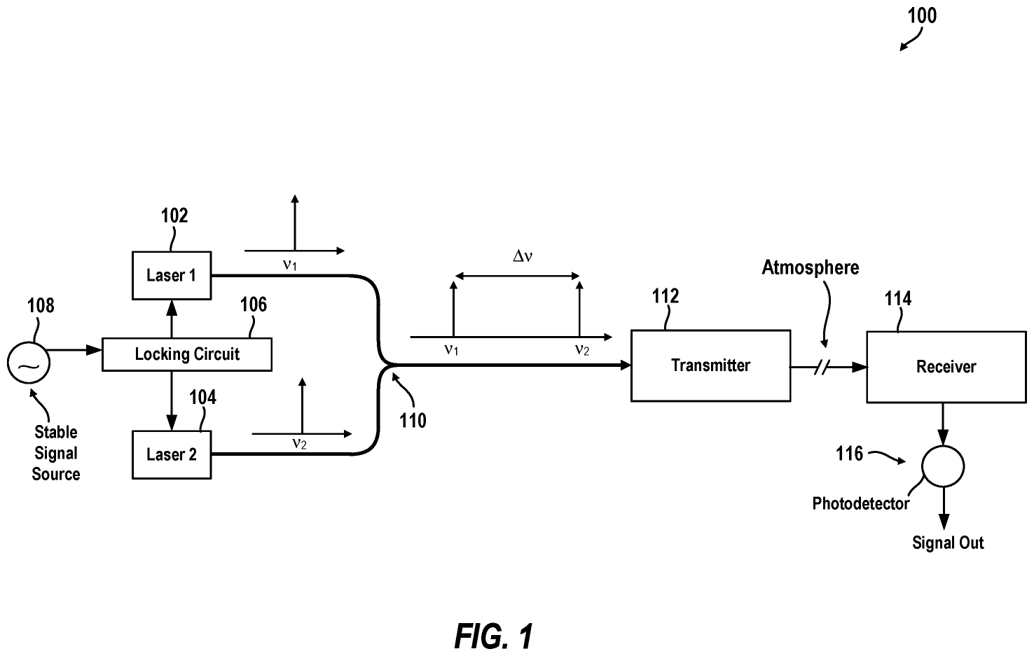

Herein, a photonic system is described that employs, in some examples, a pair of ultra-low noise lasers that produce a low noise output at the output of a photodetector at a remote location, at a frequency set by the frequency interval between the two lasers. The two lasers can be phase locked together and mutually locked to a high stability source (such as an atomic clock) at any convenient frequency (e.g., 10 MHz or 100 MHz) and upon impinging on a photodetector at the receive location, the two laser beams (or a combined or merged version of the two laser beams) produce a stabilized beat note at its output (as illustrated in FIG. 1, described below). Since the lasers frequencies (wavelength) are separated by a small value (e.g., 100 MHz) during transmission both lasers suffer virtually the same frequency deviation due to atmospheric perturbation, any frequency variations will (substantially) cancel at the output beat note produced by the photodetector. That is, any frequency deviations in the frequency of the first laser or in the frequency of the second laser are substantially similar in magnitude.

In one example, the frequency of the first laser is designated as υ₁ and the frequency of the second laser is designated as υ₂ with the frequency deviations due to external perturbations designated as δυ.

(υ₁+δυ₁)−(υ₂+δυ₂)=υ₁−υ₂, where it is assumed that δυ₁≅δυ₂.

Note that because the beat frequency (υ₁−υ₂) is a small fractional size of the laser frequencies υ₁ or υ₂, the change in each laser frequency given by δυ₁ and δυ₂ due to any change of the index of refraction of the atmosphere is essentially equal and cancel in the equation. This approximation to a zero difference in δυ₁ and δυ₂ improves when the beat frequency is small, i.e., the closer υ₁ is to υ₂. So at 100 MHz difference, for example, which is typical of an output frequency of an atomic clock, the degradation of stability can be as small as a part in 10⁻¹⁵. There are several important attributes associated with this approach. First, the architecture is considerably simplified with respect to other schemes based on optical links to transfer precise frequency. In latter approaches the stabilized signal is modulated on the laser frequency. This produces a sideband that has significantly smaller power than the carrier. The sideband may undergo a frequency shift due to dispersion and the signal to noise of the received signal due to the beat of the carrier with the modulated sideband degrades. By contrast the disclosed approach, within the approximation mentioned above, is (substantially) immune to any variation of frequency common to the two lasers, whether caused by atmospheric turbulence, scattering, etc. Furthermore, since the two lasers each have higher power than any modulated sideband on them, the received signal to noise power is substantially increased.

In this manner, a photonic system, device, apparatus, or method is provided for transfer of atomic clock stability over free-space line of sight between stationary or moving platforms. A relatively simple architecture is thus provided for precision frequency transfer between platforms, or from a single source to several locations. The photonic systems described herein utilize a pair of highly spectrally pure lasers locked to a high stability source, which can transfer the stability of the source to a received point at the output of as photodetector at any desired frequency. This allows for coherent combining of signals by several receivers each on or at a different location. Exemplary applications include, for example, for satellite communication, Doppler navigation and military applications.

### Exemplary Methods and Apparatus

FIG. 1 is a block diagram of a photonic system, device, or apparatus 100 that incudes first and second spectrally-pure lasers 102 and 104, both coupled to a locking circuit 106 that receives a stable signal from a stable signal source 108 (such as a phase locked loop circuit receiving a stable atomic clock signal at 100 MHz. A suitable laser that may be used which is sufficiently spectrally pure is a high quality semiconductor laser. The first laser (laser #1) 102 outputs a beam at υ₁ (i.e., a first frequency) and the second laser (laser #2) 104 outputs a beam at υ₂ (i.e., a second frequency) with the frequency difference between the two beams designated as Δυ. The two laser beams (or signals) are combined by an optical combiner 110 (shown in the figure by way of the two merging optical beams) into a combined (or merged) beam. The combined beam is transmitted by a transmitter 112 through the atmosphere (or, in other examples, through vacuum or through some other medium besides air). The transmitted beam is received by a receiver 114 and then applied to a photodetector 116. As explained above, when the combined beam is applied to the photodetector, a stabilized beat note is thereby detected and output, which may be output as an output signal (for input into other devices or components, not shown).

In this regard, by setting the output frequencies of the two lasers (υ₁ and υ₂) to selected frequencies, the frequency difference between the two laser beams (Δυ) can also be set (or continuously tuned) to some desired or selected value. Hence, the beat note detected at the receiver can also be set (or continuously tuned) to a desired or selected value. In this manner, the transmitter portion of the system can generate a precise frequency (e.g., the frequency represented by the beat note Δυ) and transfer a signal that carries that precise frequency over optical fiber or free space to the receiver portion of the system at a remote location (e.g., a location separated from the transmitter location), with the receiver portion then outputting a signal with that precise frequency. In this manner, one-way, optical transmission of the precise frequency is thereby provided.

It should be noted that transmission in space, where any atmospheric perturbations are absent, will often provide a nearly exact replica of the frequency from the transmit source to the remote receiver with preservation of the phase the received signal with respect to the transmitted signal. Knowledge of the relative Doppler velocity of the two locations with respect to each other can be used to synchronize a clock on the receiving platform to the clock on the receiving platform.

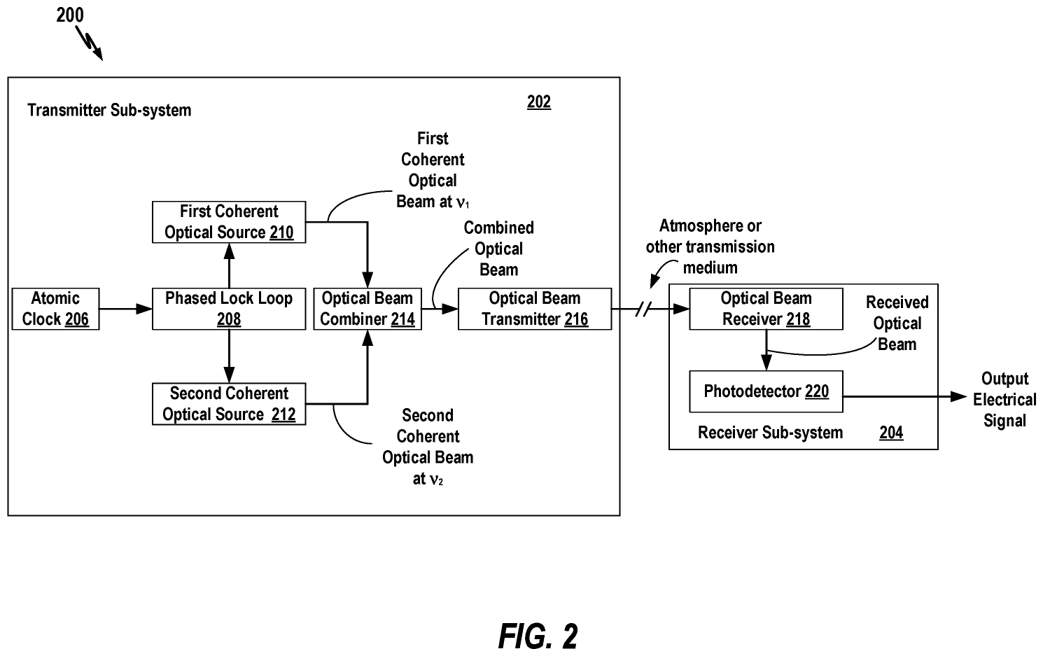

FIG. 2 illustrates a photonic system, device, or apparatus 200 that includes a transmitter portion or sub-system 202 and a receiver portion or sub-system 204. The transmitter sub-system 202 includes an atomic clock 206 that provides a very stable signal to a phase locked loop (PLL) 208 (or other suitable locking circuit). Alternatively, the signal source may be a disciplined oscillator or any other stable source of frequency. A first coherent optical source 210 and a second coherent optical source 212 are mutually locked to the PLL, as described above. The first coherent optical source 210 outputs a first coherent optical beam at υ₁. Concurrently, the second coherent optical source 212 outputs a second coherent optical beam at υ₂. The two beams are combined or merged using an optical beam combiner 214. For example, if the two beams are routed along optic fibers, the combiner 214 may be a fiber optic combiner. The combined optical beam, which beats at a frequency based on υ₁−υ₂, is fed into an optical beam transmitter 216. In some examples, the optical transmitter may include suitable lenses and other components for directing the beam toward one or more receives through the atmosphere or other medium.

The receiver sub-system 204 includes an optical beam receiver 218, which may include suitable lenses and other components for capturing the combined beam and routing it optically to a photodetector 220, or other suitable photomixer device. As already explained, the photodetector outputs an electrical signal at a frequency based on the beat of the combined optical signal, which beats at a frequency based on υ₁−υ₂.

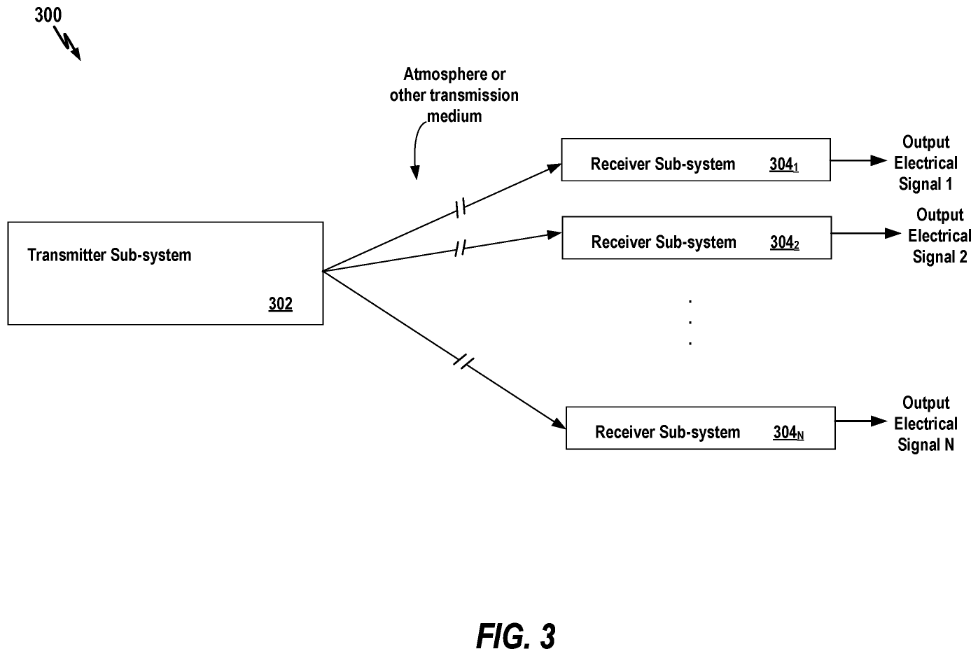

FIG. 3 illustrates a system 300 that includes one transmitter sub-system 302 (which may be configured in accordance with the transmitter sub-system shown in FIG. 2 but equipped to direct multiple versions of the combined optical beam to multiple destinations) and two or more receiver sub-systems 304₁ . . . 304_{N} (which each may be configured in accordance with the receive sub-system shown in FIG. 2 to receive one of the multiple versions of the combined optical beam). Briefly, the transmitter sub-system 302 transmits multiple versions of the same combined optical beam to the various receiver sub-systems 304₁ . . . 304_{N}, which may be moving relative to the transmitter sub-system and relative to one another. Each of the receiver sub-systems 304₁ . . . 304_{N} generates its own version of an output electrical signal (denoted output signal 1, output signal 2, etc.) for feeding into other processing components, not shown. In one particular example, the transmitter sub-system 302 may be installed on the ground and the various receiver sub-systems 304₁ . . . 304_{N} may be installed in various airborne vehicles or within satellites. The transmitter sub-system 302 may be configured so that the beat in the combined optical signal represents a very stable clock signal, so that each of the devices that receive the combined signal may use the clock signal in their respective processing components.

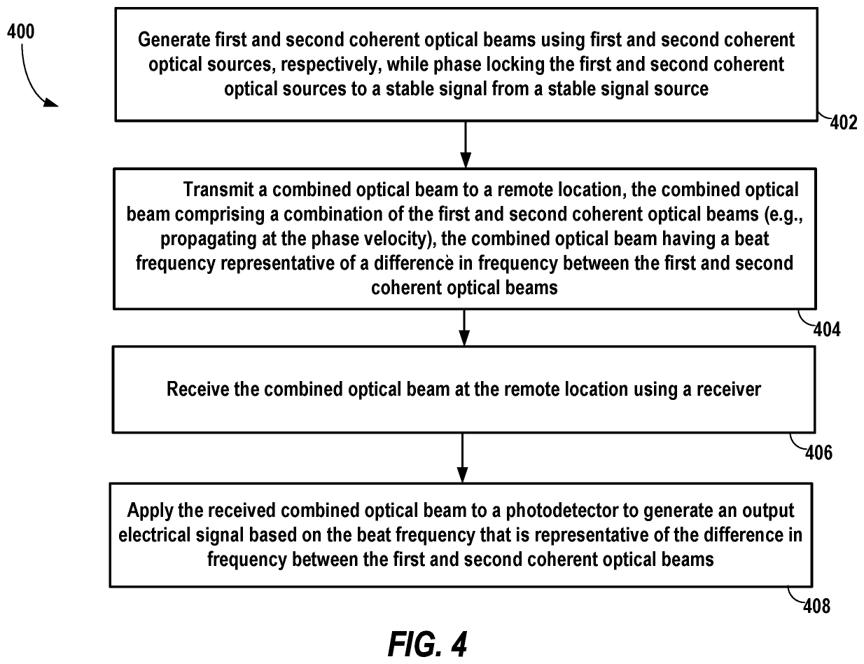

FIG. 4 illustrates a method 400 that may be performed by the photonic systems of FIG. 1, 2, 3 or 5 (discussed below) or by other suitably-equipped systems, devices, or apparatus. Briefly, at 402, a transmit sub-system of the photonic system generates first and second coherent optical beams using first and second coherent optical sources, respectively, while phase locking the first and second coherent optical sources to a stable signal from a stable signal source. At 404, the transmit sub-system of the photonic system transmits a combined optical beam to a remote location, the combined optical beam comprising a combination of the first and second coherent optical beams (e.g., propagating at the phase velocity), the combined optical beam having a beat frequency representative of a difference in frequency between the first and second coherent optical beams. At 406, a receive sub-system of the photonic system receives the combined optical beam at the remote location using a receiver. At 408, a receive sub-system of the photonic system applies the received combined optical beam to a photodetector to generate an output electrical signal based on the beat frequency that is representative of the difference in frequency between the first and second coherent optical beams. As already explained, multiple receivers at different locations may be provided, with each of the receivers receiving a version of the combined optical beam.

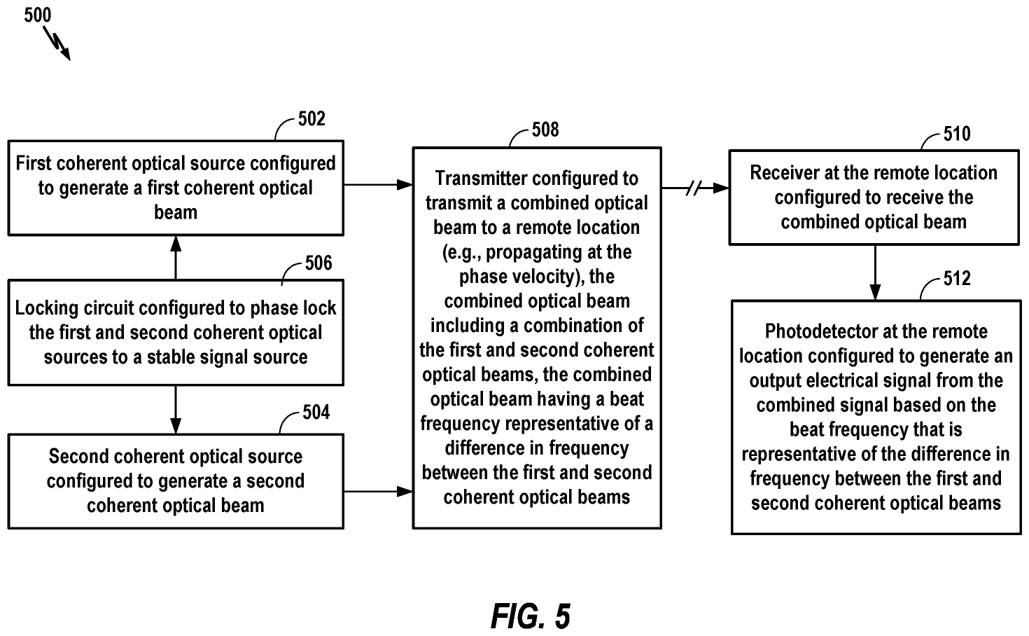

FIG. 5 illustrates an optical system 500 that includes a first coherent optical source 502 configured to generate a first coherent optical beam, and a second coherent optical source 504 configured to generate a second coherent optical beam. The optical system 500 also includes a locking circuit 506 configured to phase lock the first and second coherent optical sources to a stable signal source, and a transmitter 508 configured to transmit a combined optical beam to a remote location, the combined optical beam including a combination of the first and second coherent optical beams, the combined optical beam having a beat frequency representative of a difference in frequency between the first and second coherent optical beams. The optical system 500 also includes a receiver 510 at the remote location configured to receive the combined optical beam, and a photodetector 512 at the remote location configured to generate an output electrical signal from the combined signal based on the beat frequency that is representative of the difference in frequency between the first and second coherent optical beams.

In at least some examples, means may be provided for performing the functions illustrated in FIG. 5 and/or other functions illustrated or described herein. For example, the means may include one or more of: means, such as the first coherent optical source 502, for generating a first coherent optical beam; means, such as the second coherent optical source 504, for generating a second coherent optical beam; means, such as the locking circuit 506, for locking the first and second coherent optical sources to a stable signal source; means, such as the transmitter 508, for transmitting a combined optical beam to a remote location, the combined optical beam including a combination of the first and second coherent optical beams, the combined optical beam having a beat representative of a difference in frequency between the first and second coherent optical beams; means, such as the receiver 510 at the remote location, for receiving the combined optical beam; means, such as photodetector 512 at the remote location, for generating an output electrical signal from the combined signal based on the beat that is representative of the difference in frequency between the first and second coherent optical beams.

### Additional Aspects and Considerations

Note that one or more of the components, steps, features, and/or functions illustrated in FIGS. 1, 2, 3, 4, and/or 5 may be rearranged and/or combined into a single component, step, feature or function or embodied in several components, steps, or functions. Additional elements, components, steps, and/or functions may also be added without departing from the invention.

The word “exemplary” is used herein to mean “serving as an example, instance, or illustration.” Any implementation or aspect described herein as “exemplary” is not necessarily to be construed as preferred or advantageous over other aspects of the disclosure. Likewise, an aspect is an implementation or example. Reference in the specification to “an aspect,” “one aspect,” “some aspects,” “various aspects,” or “other aspects” means that a particular feature, structure, or characteristic described in connection with the aspects is included in at least some aspects, but not necessarily all aspects, of the present techniques. The various appearances of “an aspect,” “one aspect,” or “some aspects” are not necessarily all referring to the same aspects. Elements or aspects from an aspect can be combined with elements or aspects of another aspect.

The term “coupled” may mean that two or more elements are in direct physical or electrical contact. However, “coupled” may also mean that two or more elements are not in direct contact with each other, but yet still co-operate or interact with each other.

Not all components, features, structures, characteristics, etc. described and illustrated herein need be included in a particular aspect or aspects. If the specification states a component, feature, structure, or characteristic “may,” “might,” “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although some aspects have been described in reference to particular implementations, other implementations are possible. Additionally, the arrangement and/or order of elements or other features illustrated in the drawings and/or described herein need not be arranged in the particular way illustrated and described. Many other arrangements are possible according to some aspects.

Also, it is noted that the aspects of the present disclosure may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing aspects of the disclosure are merely examples and are not to be construed as limiting the invention. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. An optical system, comprising:
first and second coherent optical sources configured to generate first and second coherent optical beams, respectively;
a locking circuit configured to phase lock the first and second coherent optical sources to a stable signal source;
a transmitter configured to transmit a combined optical beam to a remote location, the combined optical beam comprising a combination of the first and second coherent optical beams, the combined optical beam having a beat frequency representative of a difference in frequency between the first and second coherent optical beams;
a receiver at the remote location configured to receive the combined optical beam; and
a photodetector at the remote location configured to generate an output electrical signal from the combined optical beam based on the beat frequency that is representative of the difference in frequency between the first and second coherent optical beams.

2. The system of claim 1, wherein the first and second coherent optical sources are first and second lasers, respectively.

3. The system of claim 1, wherein the locking circuit is a phase locked loop circuit.

4. The system of claim 1, wherein the stable source is one or more of an atomic clock and a disciplined oscillator.

5. The system of claim 1, further comprising an optical combiner for combining the first and second coherent optical beams to produce the combined optical beam.

6. The system of claim 1, wherein the transmitter and the receiver are separated by air so that the combined optical beam is transmitted through the air.

7. The system of claim 1, wherein the transmitter and the receiver are separated by at least one kilometer (km).

8. The system of claim 1, wherein the transmitter and the receiver are configured to move relative to one another.

9. The system of claim 1, wherein the receiver is one of a plurality of receivers, each receiving a version of the combined optical beam.

10. The system of claim 1, wherein the first coherent optical beam has a first frequency and the second coherent optical beam has a second frequency and any frequency deviations in the first frequency or in the second frequency are substantially similar in magnitude.

11. A method comprising:
generating first and second coherent optical beams using first and second coherent optical sources, respectively, while phase locking the first and second coherent optical sources to a stable signal from a stable signal source;
transmitting a combined optical beam to a remote location, the combined optical beam comprising a combination of the first and second coherent optical beams, the combined optical beam having a beat frequency representative of a difference in frequency between the first and second coherent optical beams;
receiving the combined optical beam at the remote location using a receiver; and
applying the received combined optical beam to a photodetector to generate an output electrical signal based on the beat frequency that is representative of the difference in frequency between the first and second coherent optical beams.

12. The method of claim 11, wherein the first and second coherent optical beams are generated using first and second lasers, respectively.

13. The method in claim 11, wherein the first and second coherent optical beams are generated by two modes of the same laser.

14. The method of claim 11, wherein the first and second coherent optical sources, are locking using a phase locked loop circuit.

15. The method of claim 11, further comprising generating the stable signal using one or more of an atomic clock and a disciplined oscillator.

16. The method of claim 11, further comprising combining the first and second coherent optical beams to produce the combined optical beam using an optical combiner.

17. The method of claim 11, wherein the combined optical beam is transmitted through air to the receiver.

18. The method of claim 11, wherein the combined optical beam is transmitted using a transmitter, and the transmitter and the receiver are moving relative to one another.

19. The method of claim 11, wherein the receiver is one of a plurality of receivers, each receiving a version of the combined optical beam.

20. An apparatus comprising:
means for generating first and second coherent optical beams using first and second coherent optical sources, respectively, while phase locking the first and second coherent optical sources to a stable signal from a stable signal source;
means for transmitting a combined optical beam to a remote location, the combined optical beam comprising a combination of the first and second coherent optical beams, the combined optical beam having a beat frequency representative of a difference in frequency between the first and second coherent optical beams;
means for receiving the combined optical beam at the remote location using a receiver; and
means for applying the received combined optical beam to a photodetector to generate an output electrical signal based on the beat frequency that is representative of the difference in frequency between the first and second coherent optical beams.
